(19) United States
(12) Patent Application Publication
(10) Pub. No.: US 2015/0134803 A1
(43) Pub. Date: May 14, 2015

(54) Networking Method and Device

(71) Applicant: Tao Li, Shenzhen (CN)

(72) Inventor: Tao Li, Shenzhen (CN)

(73) Assignee: ZTE Corporation, Shenzhen, Guangdong (CN)

(21) Appl. No.: 14/397,987

(22) PCT Filed: Jul. 12, 2012
(86) PCT No.: PCT/CN2012/078553

§ 371 Date: Oct. 30, 2014

(30) Foreign Application Priority Data
May 8, 2012 (CN) 201210140163.0

(51) Int. Cl. H04L 12/24; H04L 29/08

(52) U.S. Cl. CPC H04L 41/0226; H04L 67/141
USPC 709/223

(57) ABSTRACT

A networking method and networking device are disclosed. The method includes determining a platform type of a terminal according to the port information of the terminal; and searching for a networking manner corresponding to the determined platform type according to a preset corresponding relationship between the platform type of the terminal and the networking manner, and connecting the terminal with a network according to the found networking manner. A corresponding device is also disclosed. The device includes a platform type determination module configured to determine a platform type of a terminal according to the port information of the terminal, and a networking module configured to search for a networking manner corresponding to the determined platform type according to a preset corresponding relationship between the platform type of the terminal and the networking manner, and connect the terminal with a network according to the found networking manner. The method and device can prevent a user from determining an available networking manner by testing networking manners one by one, and the operation of the user can be simplified.

### TECHNICAL FIELD

The disclosure relates to the technical field of communications, in particular to a networking method and a networking device.

### BACKGROUND

Along with the widespread use of a wireless network, a user pays increasing attention to the quality of wireless communication service, and wireless data service is closely associated with a wireless data terminal. In recent years, the use of a data service through a wireless data terminal becomes increasingly popular. Based on the advantages of the wireless data terminal such as small size, lightweight, convenience in carrying and capability of implementing data service any time anywhere, such data service also becomes more and more popular.

At present, a 2^{nd} generation Internet Protocol version 4 (IPv4) technology is mainly used for accessing the Internet, while Internet Protocol version 6 (IPv6) is being continuously developed and improved, and will take the place of IPv4 which is widely used in the near future. However, IPv4-based Personal Computers (PC) and network device are mainly adopted in a current network, and an application range of IPv4 is very broad, so that the transition from IPv4 to IPv6 is impossible to be realized at one time. When IPv4 and IPv6 coexist, a user can only select IPv4 or IPv6 for networking in a one-by-one testing way during daily use, which results in inconvenience in the networking operation.

### SUMMARY

The embodiments of the disclosure provide a networking method and a corresponding device, which prevent a user from testing an IPv4-based networking manner and an IPv6-based networking manner one by one to determine a networking manner to be used and can simplify the networking operation of the user.

A networking method provided by the disclosure includes:

determining a platform type of a terminal according to the port information of the terminal; and searching for a networking manner corresponding to the determined platform type according to a preset corresponding relationship between a platform type of a terminal and a networking manner, and connecting the terminal with a network according to a found networking manner.

Determining the platform type of the terminal according to the port information of the terminal includes:

acquiring driver information and the port information of the terminal; and

determining the platform type of the terminal corresponding to the acquired port information of the terminal according to a corresponding relationship between the port information and the platform type in the driver information.

Acquiring the port information of the terminal includes:

acquiring the port information corresponding to a network port of the terminal.

Determining the platform type of the terminal corresponding to the acquired port information of the terminal includes:

searching for terminal information corresponding to the acquired port information of the terminal according to a corresponding relationship between port information and terminal information in the driver information; and

determining the platform type of the terminal corresponding to the found terminal information according to a corresponding relationship between terminal information and a platform type in the driver information.

The terminal information includes manufacturer information, product information and a port number.

The networking manner is an IPv4-based networking manner or an IPv6-based networking manner.

A networking device provided by the embodiment of the disclosure includes:

a platform type determination module, configured to determine a platform type of a terminal according to port information of the terminal; and

a networking module, configured to search for a networking manner corresponding to the determined platform type according to a preset corresponding relationship between a platform type of a terminal and a networking manner, and connect the terminal with a network according to a found networking manner.

The platform type determination module includes:

an information acquisition unit, configured to acquire driver information and the port information of the terminal; and

a platform type searching unit, configured to determine the platform type of the terminal corresponding to the acquired port information of the terminal according to a corresponding relationship between port information and a platform type in the driver information.

The information acquisition unit is configured to acquire the port information corresponding to a network port of the terminal.

The platform type searching unit is configured to search for terminal information corresponding to the acquired port information of the terminal according to a corresponding relationship between port information and terminal information in the driver information, and determine the platform type of the terminal corresponding to a found terminal information according to a corresponding relationship between the terminal information and the platform type in the driver information.

According to the embodiments of the disclosure, a networking manner of a terminal is determined by identifying the port of the terminal and searching the driver information for the platform type of the terminal according to the port information of the port, and is further used for networking. The networking method according to the embodiment of the disclosure can be easily used by a user, and the user does not need to test the networking manners one by one for determining an available networking manner.

### BRIEF DESCRIPTION OF THE DRAWINGS

FIG. 1 is a flowchart of a networking method according to an embodiment of the disclosure;

FIG. 2 is a flowchart of determining a platform type in a method embodiment of the disclosure;

FIG. 3 is a flowchart of implementing the determination of a platform type corresponding to the port information of a terminal in a method embodiment of the disclosure;

FIG. 4 is a flowchart of a specific method embodiment of the disclosure;

FIG. 5 is a structure diagram of an device embodiment of the disclosure; and

FIG. 6 is a structure diagram of a system formed by a device coupled with a terminal of the disclosure.

### DETAILED DESCRIPTION

A networking method provided by the disclosure may prevent a user from testing networking manners one by one, and make the networking operation easier for the user.

A method embodiment of the disclosure is described below with reference to the drawings. As shown in FIG. 1, the method according to the embodiment includes:

Step S101: determining a platform type of a terminal according to port information of the terminal;

Step S102: searching for a networking manner corresponding to the determined platform type according to a preset corresponding relationship between the platform type of the terminal and the networking manner, and connecting the terminal with a network according to the found networking manner.

The terminal is powered on by a PC after being connected with the PC, the PC maps a drive program and an installation program of wireless data terminal management software, which are stored in the terminal, through an operating system, and the drive program and the wireless terminal management program are installed in the PC. The terminal in the embodiment may be a wireless terminal or a wired terminal, and the wireless terminal is taken as an example in the embodiment.

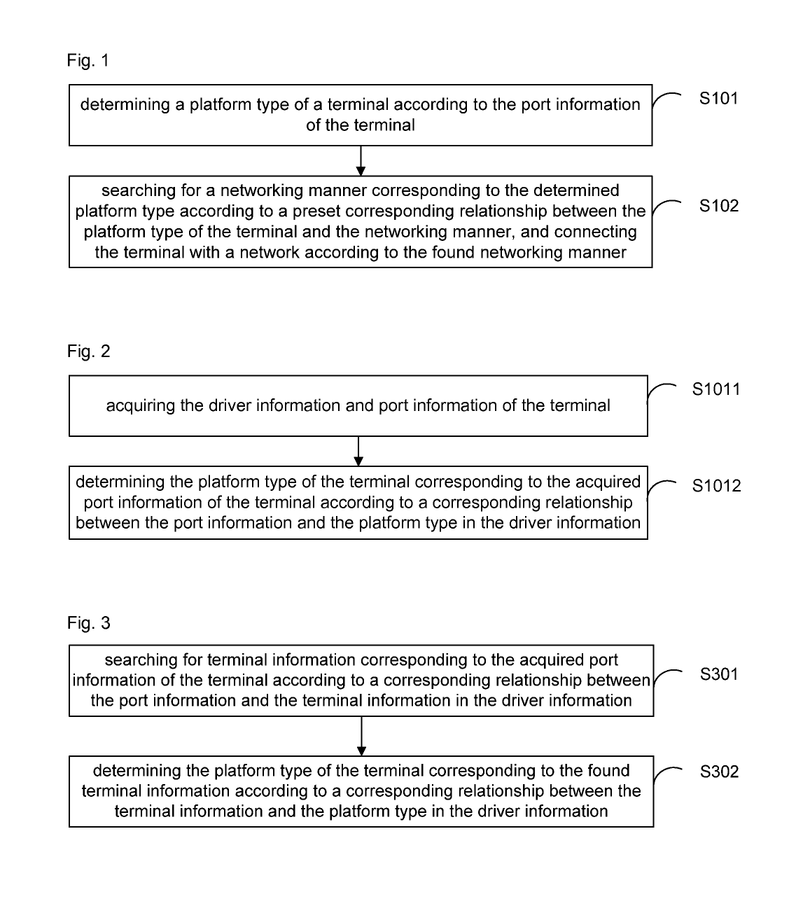

After the drive program and the wireless terminal management program are installed, the platform type of the terminal is required to be determined. Therefore, specific steps in step S101 are shown as FIG. 2, including:

S1011: acquiring the driver information and port information of the terminal;

S1012: determining the platform type of the terminal corresponding to the acquired port information of the terminal according to a corresponding relationship between the port information and the platform type in the driver information.

After the drive program and the wireless terminal management program are installed by the PC through the operating system, the PC maps all ports of the terminal, and further acquires all port information. The drive program installed in the PC includes the driver information. Meanwhile, the PC searches the corresponding relationship between the port information and the platform type in the driver information for the platform type corresponding to the port information through the drive program. Therefore, the platform type of the terminal can be determined according to the acquired port information of the terminal and the corresponding relationship between the port information and the platform type in the driver information. When searching for the platform type corresponding to the port information, it is usually in the driver information that only the network port in the terminal can form the corresponding relationship with the platform type, therefore, the corresponding platform type is determined according to the port information of the network port in the ports after the port information is acquired.

When the platform type is determined according to the driver information, the corresponding relationship between the port information and the platform type in the driver information is actually a corresponding relationship between the port information and terminal information and a corresponding relationship between the terminal information and the platform type of the terminal. Therefore, preferably, the process of determining the platform type of the terminal corresponding to the acquired port information of the terminal includes: searching for the terminal information corresponding to the acquired port information of the terminal according to the corresponding relationship between the port information and the terminal information in the driver information, and determining the platform type of the terminal corresponding to the found terminal information according to the corresponding relationship between the terminal information and the platform type in the driver information, wherein the terminal information includes manufacturer information, product information and a port number.

Then, a method for determining the platform type of the terminal corresponding to the acquired port information of the terminal, as shown in FIG. 3, includes:

Step S301: searching for the terminal information corresponding to the acquired port information of the terminal according to the corresponding relationship between the port information and the terminal information in the driver information;

here, the terminal information includes the manufacturer information, the product information and the port number.

Step S302: determining the platform type of the terminal corresponding to the found terminal information according to the corresponding relationship between the terminal information and the platform type in the driver information.

In addition, after the platform type of the terminal is determined in this step, a character representing the platform type is further added into a driver information table of the ports.

When the drive program is installed, the PC adds the platform type determined by the above-mentioned steps into an identification field ZPlatform Value for identifying the platform type in the driver information table in a memory of the PC through the drive program, and a networking manner can be determined according to the identification field in step S102. The Value may be set to be the name of a manufacturer such as Qualcom or Icera, or set as any value as long as there is a networking manner in a corresponding relationship with the identification field and a corresponding networking manner can be found according to the identification field. After identification information is set, the PC also creates a corresponding class family object through the drive program for the terminal ports mapped by the PC, maps a device connection file for an application layer to use, and makes preparation for the creation of a communication connection between the PC and the terminal.

After the platform type of the terminal is determined, as shown in step S102, the corresponding networking manner can be found, that is, whether an IPv4-based networking manner or an IPv6-based networking manner is adopted for the creation of the connection between the PC and the terminal is determined. When the IPv4-based networking manner is determined to be adopted, whether an IPv4-based Remote Access Service (RAS) manner or an IPv4-based Network Driver Interface Specification (NDIS) manner is adopted for the connection can further be determined; or when the IPv6-based networking manner is determined to be adopted, whether an IPv6-based RAS manner or an IPv6-based NDIS manner is adopted for the connection can further be determined.

The step of determining the networking manner according to the platform type of the terminal is executed by the wireless terminal management program installed in the PC.

After the platform type is determined, the PC selects the corresponding networking manner according to the determined platform type, and such a process is implemented through the wireless terminal management program. When the user controls the PC to initiate a networking request through the wireless terminal management program, the PC creates a connection with the network according to the determined networking manner. When the wireless terminal management program fails in networking, the user can be prompted.

In the above embodiment, the platform type of the terminal is finally obtained through the acquired port information of the terminal and the corresponding relationship between the port information and the platform type in the drive program. After the networking manner is determined according to the platform type, the determined networking manner is used for connection. Meanwhile, when the corresponding relationship between the port information and the platform type in the drive program is utilized, corresponding terminal device information is found according to the port information, and the platform type is found according to the device information. By the method provided by the embodiment, the user can determine a correct networking manner without testing the networking manners one by one until the networking is successful, and the operation performed by the user during the networking can be simplified.

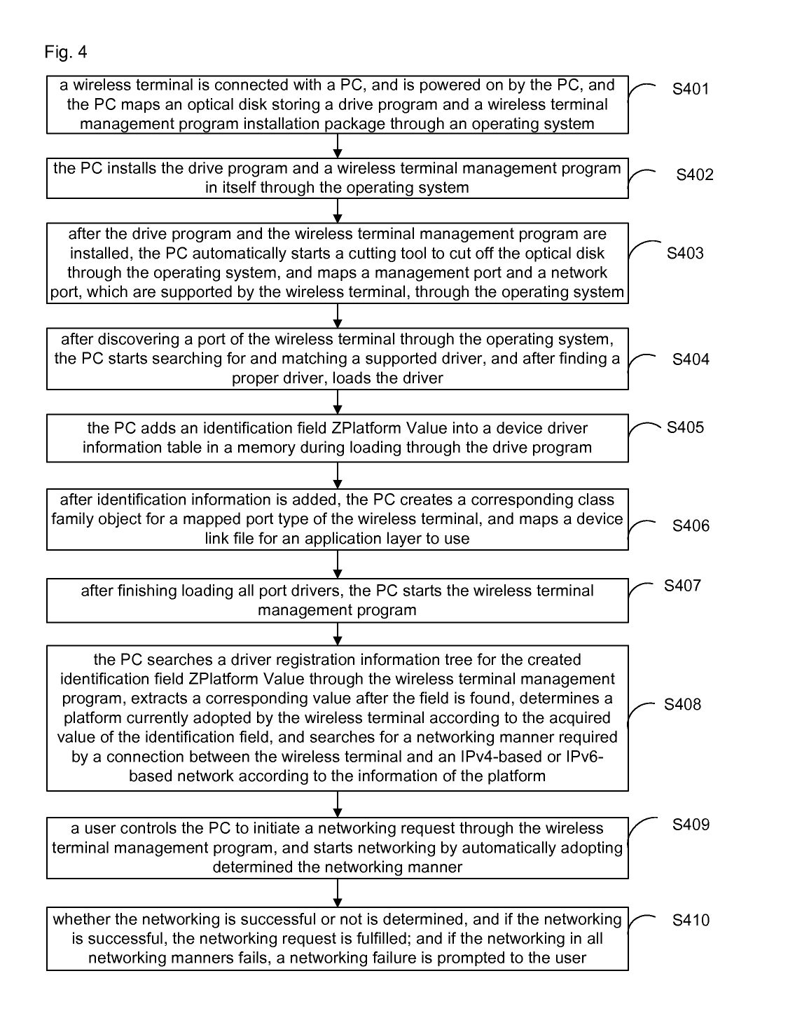

A specific method embodiment of the disclosure is described below with reference to FIG. 4.

Step S401: A wireless terminal is connected with a PC, and is powered on by the PC, and the PC maps an optical disk storing an installation package of a drive program and a wireless terminal management program through an operating system.

Step S402: The PC installs the drive program and the wireless terminal management program in itself through the operating system.

Step S403: After the drive program and the wireless terminal management program are installed, the PC automatically starts a cutting tool to cut off the optical disk through the operating system, and maps a management port and a network port, which are supported by the wireless terminal, through the operating system.

Step S404: After discovering a port of the wireless terminal through the operating system, the PC starts searching for and matching a supported driver, and after finding a proper driver, loads the driver.

In steps S401-S404, after the wireless terminal is plugged into the PC, the corresponding driver and the wireless terminal management program are installed in the PC for the application of the wireless terminal so as to get ready for the use of the wireless terminal. In step S404, the PC executes the process of searching for a platform type according to port information through the drive program, namely searching for the platform type corresponding to the port information according to driver information.

Step S405: The PC adds an identification field ZPlatform Value into a device driver information table in a memory during loading through the drive program.

The identification field is a self-defined field, and another character can be adopted for a specific name of the field. A value of the field is a type of current device, which is written according to driver configuration file information, such as Qualcom and Icera, which are also self-defined fields and whose specific names can also be changed into other characters.

In step S405, the determined platform type is written into the driver information when the driver is loaded.

Step S406: After identification information is added, the PC creates a corresponding class family object for a mapped port type of the wireless terminal, and maps a device link file for an application layer to use.

The step S406 prepares for a communication connection between the wireless terminal and the PC.

Step S407: After finishing loading all port drivers, the PC starts the wireless terminal management program.

Step S408: The PC searches a driver registration information tree for the identification field ZPlatform Value created in S405 through the wireless terminal management program, extracts a corresponding value after the field is found, determines a platform currently adopted by the wireless terminal according to the acquired value of the identification field, and searches for a networking manner required by a connection between the wireless terminal and an IPv4-based or IPv6-based network according to the information of the platform.

The PC continues determining the required networking manner according to the determined platform type through the wireless terminal management program.

Step S409: A user controls the PC to initiate a networking request through the wireless terminal management program, and starts networking by automatically adopting the networking manner determined in S408.

Step S410: Whether the networking is successful or not is determined, and if the networking is successful, the networking request is fulfilled; and if the networking in all networking manners fails, a networking failure is prompted to the user.

The embodiment includes the steps subsequent to the plugging of the wireless terminal into the PC to networking. When the driver is loaded in S404, the corresponding platform type can be found according to the port information, and the networking manner is determined according to the platform type in S405. The user in need of connection is only required to trigger the wireless terminal management program, and the PC can be connected to the network through the wireless terminal management program, so that troubles of the user in the adoption of a one-by-one testing method for the determination of the networking manner are avoided.

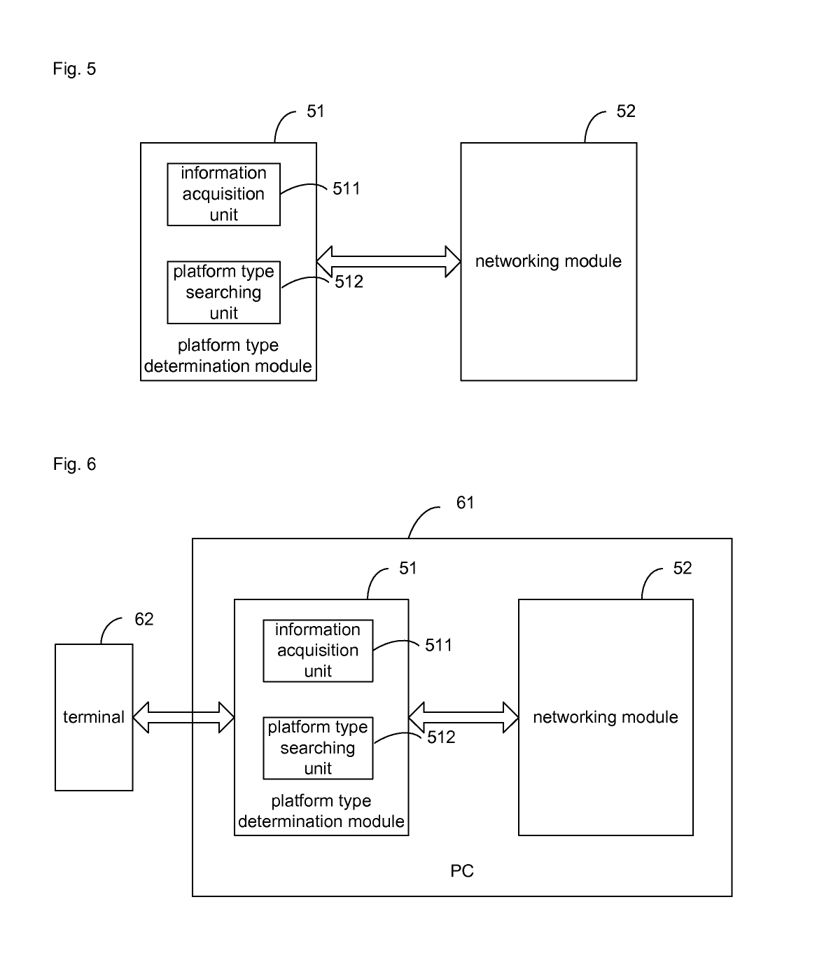

An device embodiment provided by the disclosure is described below with reference to FIG. 5, and as shown in FIG. 5, the device includes a platform type determination module 51 and a networking module 52, wherein

the platform type determination module 51 is configured to determine a platform type of a terminal according to the port information of the terminal; and

the networking module 52 is configured to search for a networking manner corresponding to the determined platform type according to a preset corresponding relationship between the platform type of the terminal and the networking manner, and connect the terminal with a network according to the found networking manner.

The platform type determination module 51 further includes an information acquisition unit 511 and a platform type searching unit 512, wherein

the information acquisition unit 511 is configured to acquire the driver information and port information of the terminal; and

the platform type searching unit 512 is configured to determine the platform type of the terminal corresponding to the acquired port information of the terminal according to a corresponding relationship between the port information and the platform type in the driver information.

The information acquisition unit 511 is specifically configured to acquire the port information corresponding to a network port of the terminal.

The platform type searching unit 512 is specifically configured to search for terminal information corresponding to the acquired port information of the terminal according to a corresponding relationship between the port information and the terminal information in the driver information, and determine the platform type of the terminal corresponding to the found terminal information according to a corresponding relationship between the terminal information and the platform type in the driver information.

The terminal information includes manufacturer information, product information and a port number.

The networking manner includes an IPv4-based networking manner or an IPv6-based networking manner.

According to the device provided by the embodiment, a corresponding networking manner can be determined according to the port information of a terminal, and the terminal can be directly connected with the network according to the determined networking manner. The user is prevented from take a test one by one to find the networking manner, and the operation of the user is simplified.

The device is applied at a PC side, and FIG. 6 is a structure diagram after a connection between a PC and a terminal is created.

A platform type determination module 51 in the PC 61 is configured to acquire a platform type of the terminal 62; and

a networking module 52 is configured to determine a networking manner of the terminal 62 according to the platform type determined by the platform type determination module 51, and when networking is required, the PC 61 is connected in the determined networking manner.

Obviously, those skilled in the art can make various modifications and variations to the disclosure without departing from the spirit and scope of the disclosure. Thus, if these modifications and variations of the disclosure fall within the scope of the claims of the disclosure and equivalent technologies thereof, the disclosure is also intended to include these modifications and variations.

What is claimed is:

1. A networking method, comprising:
determining a platform type of a terminal according to port information of the terminal; and
searching for a networking manner corresponding to the determined platform type according to a preset corresponding relationship between a platform type of a terminal and a networking manner, and connecting the terminal with a network according to a found networking manner.

2. The networking method according to claim 1, wherein determining the platform type of the terminal according to the port information of the terminal comprises:
acquiring driver information and the port information of the terminal; and
determining the platform type of the terminal corresponding to the acquired port information of the terminal according to a corresponding relationship between the port information and the platform type in the driver information.

3. The networking method according to claim 2, wherein acquiring the port information of the terminal comprises:
acquiring the port information corresponding to a network port of the terminal.

4. The networking method according to claim 2, wherein determining the platform type of the terminal corresponding to the acquired port information of the terminal comprises:
searching for terminal information corresponding to the acquired port information of the terminal according to a corresponding relationship between port information and terminal information in the driver information; and
determining the platform type of the terminal corresponding to the found terminal information according to a corresponding relationship between terminal information and a platform type in the driver information.

5. The networking method according to claim 4, wherein the terminal information comprises manufacturer information, product information and a port number.

6. The networking method according to claim 1, wherein the networking manner is an Internet Protocol version 4 (IPv4)-based networking manner or an Internet Protocol version 6 (IPv6)-based networking manner.

7. A networking device, comprising:
a platform type determination module, configured to determine a platform type of a terminal according to port information of the terminal; and
a networking module, configured to search for a networking manner corresponding to the determined platform type according to a preset corresponding relationship between a platform type of a terminal and a networking manner, and connect the terminal with a network according to a found networking manner.

8. The networking device according to claim 7, wherein the platform type determination module comprises:
an information acquisition unit, configured to acquire driver information and the port information of the terminal; and
a platform type searching unit, configured to determine the platform type of the terminal corresponding to the acquired port information of the terminal according to a corresponding relationship between port information and a platform type in the driver information.

9. The networking device according to claim 8, wherein the information acquisition unit is configured to acquire the port information corresponding to a network port of the terminal.

10. The device according to claim 8, wherein the platform type searching unit is configured to search for terminal information corresponding to the acquired port information of the terminal according to a corresponding relationship between port information and terminal information in the driver information, and determine the platform type of the terminal corresponding to found terminal information according to a corresponding relationship between terminal information and a platform type in the driver information.

11. The networking method according to claim 3, wherein determining the platform type of the terminal corresponding to the acquired port information of the terminal comprises:
searching for terminal information corresponding to the acquired port information of the terminal according to a corresponding relationship between port information and terminal information in the driver information; and
determining the platform type of the terminal corresponding to the found terminal information according to a corresponding relationship between terminal information and a platform type in the driver information.

12. The networking method according to claim 11, wherein the terminal information comprises manufacturer information, product information and a port number.

13. The networking method according to claim 2, wherein the networking manner is an Internet Protocol version 4 (IPv4)-based networking manner or an Internet Protocol version 6 (IPv6)-based networking manner.

14. The networking method according to claim 3, wherein the networking manner is an Internet Protocol version 4 (IPv4)-based networking manner or an Internet Protocol version 6 (IPv6)-based networking manner.

15. The device according to claim 9, wherein the platform type searching unit is configured to search for terminal information corresponding to the acquired port information of the terminal according to a corresponding relationship between port information and terminal information in the driver information, and determine the platform type of the terminal corresponding to found terminal information according to a corresponding relationship between terminal information and a platform type in the driver information.
